(19) United States
(12) Patent Application Publication
(10) Pub. No.: US 2013/0110656 A1
(43) Pub. Date: May 2, 2013

(54) Smart payment system

(71) Applicants: Wunchun Chau, Redmond, WA (US); William Pittman, Redmond, WA (US)

(72) Inventors: Wunchun Chau, Redmond, WA (US); William Pittman, Redmond, WA (US)

(21) Appl. No.: 10/883,597

(22) Filed: Jul. 1, 2004

Related U.S. Application Data
(60) Provisional application No. 60/501,282, filed on Sep. 9, 2003.

(51) Int. Cl. G06Q 20/20

(52) U.S. Cl. CPC G06Q 20/204
USPC 705/17

(57) ABSTRACT

A versatile payment system connected to the payment network for the use with a POS application is disclosed. The payment system can be configured as a stand-alone payment system or a payment system integrated with the POS application. Versatility is achieved by (1) running the service manager in the background, allowing it to communicate with the POS application, (2) providing a setup menu allowing the user to configure its integration with the POS application, and (3) using a simple data-exchanging schema allowing the service manager and the POS application to exchange data such as authorization codes and amount of payment.

### CROSS REFERENCE TO RELATED APPLICATIONS

This patent application claims the priority from the provisional application 60/501,282 accorded with a filing date of Sep. 9, 2003.

### COPYRIGHT NOTICE AND USE PERMISSION

A portion of the disclosure of this patent document contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever. The following notice applies to the software and data as described below and in the drawings hereto: Copyright 2004, TPI Software, L.L.C., All Rights Reserved.

### FIELD OF INVENTION

The present invention relates generally to payment systems, and more particularly to payment systems integrated with Point of Sales application.

### BACKGROUND OF THE INVENTION

In a typical sale terminal, the merchant originally handles at least two kinds of transactions: sale and return transactions, and payment processing transactions. In a sale transaction, the merchant uses Point of Sales (POS) system to process an invoice, a purchase slip, or similar paper showing items sold, quantities, and customer information. In a payment transaction corresponding to the sale transaction, the merchant transfers money in terms of credit from the customer account such as a credit card account, debit account, or an associated checking account to a merchant account. Normally, such a payment transaction is conducted by a payment-processing server in the payment network. The payment-processing server is able to access to both the customer accounts and merchant accounts and transfer fund between them. In a return transaction, the merchant uses the POS system to create a return invoice showing the items returned and the amount of refund. In such a reverse payment transaction for a return transaction, fund is transferred from the merchant account to the customer account.

A variety of POS sale terminals are used in most stores and sale terminals. The terminal generally consists of hardware such as computer and other peripheral devices such as credit card reader, invoice printer, and signature pad, and an application, which is capable of processing sale transaction. It may create sale invoices or billing statements. Optionally, a storeowner may add inventory control application to its PO system to manage its entire inventory (often known as inventory control system). In such a POS system, the inventory control application manages one or more databases, which contain, among other things, item numbers such as SKU code, list prices, and optionally, sale prices and the quantities of products in stock. When a sale is made to a customer, the POS system prints a sale receipt and may update the quantity of the remaining items in stock.

One of POS sale terminal systems is disclosed in U.S. Pat. No. 6,547,129, Check Writing Point of Sales System, granted to Nichols et. al, in 2003. This system consists of logic means, memory, keyboard, card reader, check reader, and interfaces with a central computer. It can be used to process payments by credit card, debit/ATM card, and card encoded check account. The hardware limits its capability to the intended functions.

Another such POS sale terminal system is disclosed in U.S. Pat. No. 6,547,132, Point of Sale Payment Terminal, granted to Templeton et. al. in 2003. This integrated payment terminal system essentially contains a processor, memory, a housing installed with a display screen and keys, an image recognition device, and magnetic strip reader. This system may be used to process payment transactions by check, credit card, debit/ATM card, and EBT card, but is not intended to provide other functions such as managing the merchants inventory and tracking consumers purchase history.

A payment system made of a personal computer connected to a payment network is also available. One of such systems is disclosed in U.S. Pat. No. 6,038,548, System and Method for Conducting Electronic Commerce in a Computer Network Using a Cashier Desk Payment Framework, granted to Kamil on May 14, 2000. When a payment system is built with computers in a network, it is more versatile. This system, for example, can communicate with a relational database to manage, among others, the inventory of products. It is possible to add more functions.

Sophisticated POS systems have gradually incorporated more functions such as keeping track of customer information and their purchase histories. Merchants such as grocery stores and clubs, for example, issue club membership cards such as bonus cards to customers. Their POS inventory systems are capable of maintaining, among others, member addresses and their purchase histories. The capabilities of the POS systems are, however, limited to database management systems. It may also include applications for accounting, sale tax assessment, analyzing consumer purchase histories, and marketing. In a typical case when a store decides to accept a new POS inventory system. It may have to upgrade its payment system. It has to use a completely independent payment terminal or payment system, or a payment application running in the POS computer without being able to communicate with the POS application.

It is expensive and inconvenient to add a completely independent payment system because it requires additional hardware and terminal devices for reading cards and printing payment receipts. This payment arrangement is also inconvenient and susceptible to human errors. Because the POS system and the payment system do not communicate with each other, the cashier has to enter amount of payment to the payment system manually after a sale transaction is processed by the POS system. After the payment is authorized by the payment-processing server, the cashier then has to enter the authorization code and the payment method back to the sale invoice or billing statement of the POS system. When an error does happen and the cashier is unable to abort the payment, the cashier may have to correct the error by running a transaction to void the payment or process a refund. In a sale terminal with many customers in line, such mistakes can annoy customers. Also, an unnoticed mistake in processing less than correct amount can reduce the profit of the store while a mistake in charging more than the correct amount can annoy the customer. In a situation where the customer has a limited credit line or balance in the associated credit or checking account, a mistake in overcharging may embarrass the customer. This can happen because some customers may forget to read payment slips when they sign them. It may be too late to remedy the problem by the time the consumer discovers the error.

When a payment processing application resides in the same computer of the POS application, it may be integrated or “independent”. If they are not integrated, the payment system has all pitfalls that are present in the completely independent payment systems. In addition, switching the POS application and the payment application manually may be an additional source of errors. For those reasons, some POS systems and payment systems are integrated so that a sale transaction and the related payment transaction can be processed smoothly and a manual transfer of payment amount and authorization code between the two systems is unnecessary. Unfortunately, a significant effort is required to integrate a payment application with a POS application because each of the applications is developed without considering the need for communicating with the other. Moreover, merchants may have to buy new equipment and software when they move from a stand-alone payment solution to an integrated payment solution because neither POS application nor payment application provide a migration path. Because of the lack of a migration path on the part of old payment applications, merchants have to spend more upfront costs for migration.

For those reasons, there is a need for finding a way to integrate stand-alone payment system with POS application and reduce the amount of integration work to the minimum, there is a need for developing a payment system, which is able to process credit payments by card readers and computer input screen, and which has an interface providing the flexibility to integrate with virtually any POS applications.

### SUMMARY OF THE INVENTION

The payment system (FIG. 1) comprises a functional computer running an operating system, one or more POS devices connected to the computer, a payment-processing server in the payment network, network connection that allows the computer and the payment-processing server to exchange data according to a network protocol, and a service manager running in the computer.

Instead of following the case-by-case approach to integrating the application of the POS system with the application of the payment system, the present invention uses a highly flexible service manager to control the payment system. The payment system may work as either a stand-alone payment system or an integrated payment system, depending upon whether the computer has a POS application. Great flexibility is achieved by (1) running the service manager in the background, allowing it to communicate with the POS application, (2) providing a set-up menu allowing the user to configure whether it works as an integrated or non-integrated system, and (3) using a simple data-exchanging schema allowing the service manager and the POS application to exchange data such as authorization code and amount of payment.

When the computer does not host a POS application, the payment system may be set up as a stand-alone payment system. The service manager of the payment system can communicate and interact with peripheral devices such as pin-pad, card reader, and check reader to receive payment information (card data such as card number and expiration date) from the devices. If no card reader is available or if no card is swiped through the card reader, the payment system accepts payment information such as credit card number, cardholder name, and expiration date from the computer screen. In processing a payment by credit card or other type of card, the service manager acquires card information from a POS device or prompts the customer to swipe the card and reads entered card data, and then sends the collected data to the payment-processing server in the payment network for processing.

When the service manager and necessary peripheral devices are installed in the computer with a POS application (such as inventory control application), it can be configured as a payment system integrated with the POS application. The amount of integration work is the minimal. The developers of the POS application can choose how to add payment options to the POS system. In the simplest case, the POS application needs to write one single line to a text file. Most of the existing POS applications already have this function. This line contains amount of payment, and optionally, payment method, card number, expiration date, and PIN information.

After the data is written to the exchange directory, the service manager reads the file and prompts for missing data such as a payment method and then prompts the customer to swipe the card (or prompt for swiping the card first and then prompt for a payment method). The user then submits the collected data as a request to the payment-processing server for processing. After the payment request is processed, the payment service manager outputs the result in a file containing payment method, the account number, and an authorization code. The POS application then reads the file and incorporates the payment method and the authorization code into a sale invoice, a purchase slip, or a billing statement. When this integration path is used, it is unnecessary to use Dynamic Link Libraries (DLL) or to maintain tightly coupled components. In this example, the information is exchanged between the POS application and the payment system by writing and reading files. Other methods may be used to achieve the same result with similar flexibility. For example, TCP/IP, COM, DLL, HTTP POST, Web Services, RPC, and MSMQ all can be used to establish the communication between the payment system and the POS application.

When a network protocol such as TCP/IP and HTTP is used, the payment system and the POS application may be in different locations as long as they are connected physically or wirelessly and able to communicate with each other by any of existing or newly developed network protocols. In this system, the POS application (e.g., the POS system) is able to send amount of payment, identity of the payment system, and other optional information to the address of payment system and the payment system is able to send the authorization code to the POS system.

The service manager works with a variety of POS input devices, including card readers, pin-pads, signature capture devices, pole displays, check readers, check imagers, RFID readers, and all types of printers.

The payment system of the present invention has one or more advantages over the prior art systems, depending upon the situation where this system is used. In one aspect, the system is flexible and adaptable. This reduces the costs for upgrading and integrating hardware and software. In another aspect, compared with a stand-alone payment system, this system is not susceptible to human errors in transferring authorization code and amount of payment between the POS application and the payment system. The approach allows the same system to be used as a stand-alone solution initially or when the POS system is down or to act as an integrated system when the POS system is ready. Finally, compared with sale terminal arrangement consisting of a stand-alone POS system and a stand-alone payment system, it uses less hardware and store space.

Those and other aspects of the present invention will become apparent to those skilled in the art after a reading of the following detailed description of the invention together with the following drawings. It is understood that both the foregoing general description and the following detailed description are exemplary, but are not restrictive of the scope of the invention and attendant claims.

### BRIEF DESCRIPTION OF THE DRAWINGS

FIG. 1 is a diagram showing the necessary hardware components and their connections;

FIG. 2 is a screenshot showing the setup menu for the interface between the service manager and a POS system;

FIG. 3 is a flowchart showing the steps for selecting transaction type and payment method for a non-integrated payment system;

FIG. 4a is a screenshot showing the payment window for processing a credit card payment;

FIG. 4b is a screenshot showing the payment window for processing a debit card or ATM payment;

FIG. 4c is a screenshot showing the payment window for an EBT card payment;

FIG. 5 is a flowchart showing the steps for processing a credit card payment;

FIG. 6 is a flowchart showing the steps for processing a debit or ATM card payment;

FIG. 7 is a flowchart showing the steps for processing an EBT card payment;

FIG. 8 is a flowchart showing the steps for interacting with the POS application, selecting transaction type, and payment method in an integrated payment system;

FIG. 9 is a flowchart showing the steps for processing a credit card payment transaction using an integrated payment system;

FIG. 10 is a flowchart showing the steps of post-submission processes in an integrated payment system;

FIG. 11 is a flowchart showing the steps for processing a debit card payment transaction in an integrated payment system; and

FIG. 12 is flowchart showing the steps for processing an EBT card payment transaction in an integrated payment system.

### DETAILED DESCRIPTION OF THE INVENTION

In the preferred embodiment of the present invention, a POS system means all hardware and software (e.g., the application) that are necessary for performing the intended functions of the POS system. Unless inconsistent with the context, it shall include a computer running an operating system, a POS application for processing sale receipts, shipping slips, purchase slips, and/or billing statement, and, optionally, a printer and a POS device such as pin pad, card reader, and signature-capturing device. When the POS application runs in the same computer of the payment system 100, the POS is a virtual system, which comprises the shared computer, its peripherals, and all necessary software.

A. The Necessary Hardware and Connections

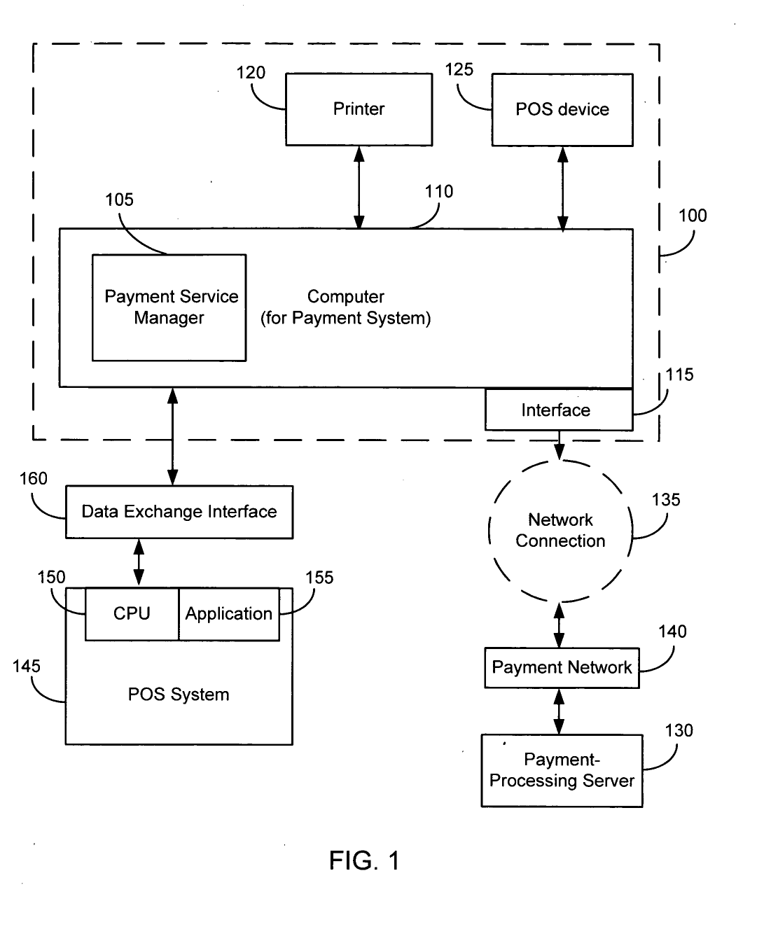

The hardware of the payment system 100 (FIG. 1) comprises two parts: the hardware and software, the service manager 105. The hardware includes a computer 110 with sufficient memory and hard disk space, a network interface 115, a printer 120, and a properly connected POS device 125 such as pin pad, card reader, and signature-capturing device. For the payment system 100 to work properly, it must be connected to a payment-processing server 130 through a network connection 135 which is physically wired to the payment network 140 of the payment-processing server 130.

The network interface 115 is used in the network connection 135 which connects the computer 110 to the payment-processing server 130 in the payment network 140 so that the computer 110 and the payment-processing server 130 can exchange data according to a network protocol. The network connection 135 may be a private network (directly connected to the payment network 140), a private network connected to a public network such as Internet using any of the available physical connections such as dialup phone lines, leased phone lines, DSL, cables, and wireless. The printer 120 and the POS device 125 may be connected to the computer 110 through a serial port, USB port or parallel port as long as they are properly connected and configured.

When reference is made of wireless connection or wireless interface, the connection shall include a device capable of transmitting and receiving signals at each of the ends of the connection. A POS device 125 such as pin pad, card reader, and any of other similar devices may be wirelessly connected to the computer 110. In this case, the computer 110 has a wireless interface containing a signal transmitter and receiver, and the POS device 125 also has device capable of sending and receiving signals according to a communication protocol. The computer 110 and the POS device 125 can therefore communicate with each other. Wireless connection may be used exclusively or in addition to other cable connections.

The computer 110 may be of any type as long as it runs a proper operating system for which the service manager 105 is compiled. Thus, computers using Intel processors and operated by Microsoft s Windows, computers using Apple architecture and operated by Apple operating systems, and computers running open source operating systems such as Linux or Unix may be used. The source code of the service manager 105 can be readily modified to create executable machine code for other types of computers. To improve the security of the payment system 100, the data may be exchanged using a secured protocol by which data are encrypted in transit.

The POS system 145 contains a POS computer 150 and a POS application 155. The POS system 145 and the payment system 100 may share the same computer to save store space and operation expenses. In all flowcharts the POS system 145 and the payment system 100 are illustrated as two separate units solely for convenience. The hardware arrangements affect only the data exchange interface 160 between the POS system 145 and the payment system 100. Because the POS system 145 and the payment system 100 mostly likely reside in one single computer, the data exchange interface 160 is discussed for such a situation.

The POS system 145 and the payment system 100 may reside in two separated computers, which may be linked by a local area network, Universal Serial Port (USB) and cable, serial port and cable, or wireless interface containing a device capable of transmitting and receiving signals. If the two systems are separated, proper interface must be installed accordingly.

The payment system 100 may be connected to a LAN, WAN, or other private network. While a secured connection between the gateway of the private network and the payment network 140 is necessary to ensure the safety of payment transactions, it is not necessary when such a system is used within a private network.

When a network protocol such as TCP/IP and HTTP is used, the payment system 100 and the POS system 145 may be in different locations as long as they are connected physically or wirelessly and able to communicate with each other by any of existing or newly developed network/communication protocols. In this arrangement, the POS system 145 is able to send amount of payment, identity of the payment system 100, and other optional information to the address of the payment system 100. This information then activates the payment system 100, which reads the information to process the payment. When a card is swiped or card information is entered into the computer screen, the service manager 105 sends all acquired information to the payment-processing server 130 for processing. After the payment is approved, the payment-processing server 130 in the payment network returns a response, which is an authorization code or rejection message, back to the payment system 100, which then sends the responsive message to the POS system 145. This arrangement is particularly useful in the case where the sale transaction is processed in a remote warehouse while the customer is present at the payment system 100 or provides payment information such as credit card formation to a cashier of the payment system 100 by phone, through email, or a web form. Yet, the two systems are integrated in the sense that they process sale/return transactions and payment transactions in a coordinated manner.

B. The Service Manager Controlling the Payment System

The software includes an operating system that runs the computer 110 and the service manager 105 that control the function of the payment system 100.

In the preferred embodiment of the present invention, the service manager 105 was developed using Microsoft Visual Basic (version 6). Visual Basic is a software-developing environment commercially distributed by Microsoft Corporation. It is an object-oriented language for all Windows operating systems. It has rich functional capabilities for designing web forms, graphic user interface dialogs, and interactive menu. It also has functional capabilities for conveniently interfacing with system click-board, monitoring keystrokes and mouse activities, and interacting with other applications. Visual Basic (version 6) comes with a package and deployment wizard, which allows software developer to build executable package. Such executable package allows end users to install the service manager 105 in a computer running Microsoft Windows 95, 98, 2000, ME, and XP. In a typical installation, it automatically guides the user to install the application.

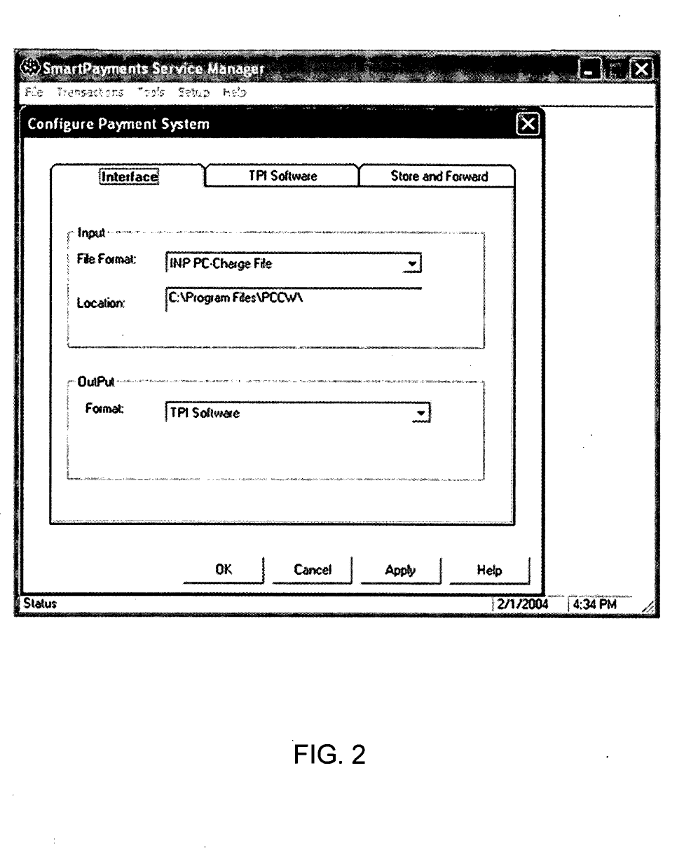

In the preferred embodiment of the present invention of the payment system 100, versatility and flexibility of the payment system 100 is achieved by use of setup pages, a file exchange method, and controlling button for activating the service manager 105. The service manager 105 has five base menu systems: File, Transaction, Tools, Setup and Help (on the background window in FIG. 2). Those setup menus allow the user to change the service manager 105 behaviors to fit particular needs.

Under the Setup menu, there are three options: Configure, Hardware and Payment. The Configure menu consists of six submenus: Login, Flat File, InPut File, Options, Prompts and Merchant. The Login menu allows the user to set up a user name and password for security protection of the system. The Flat File menu allows the user to change the field order of credit card information string so it matches the field order with particular cards. Typically, the field order of credit card information string by default is transaction type, card number, expiration date, card member name, and amount. There are additional fields for special or future needs. The Options menu may be used to turn on the function to output the device data to a flat file and allows the user to select all supported payment methods such as credit card, debit card, and EBT card. In addition, the user may run the payment system 100 in a training mode by selecting a proper check box under Options. When the payment system 100 is run in the training mode, it can imitate all processes without actually processing any payment. The Prompt menu allows the user to choose different prompts for initial prompt, amount prompt and payment method prompt. The Merchant menu allows the user to enter merchant name, address, phone number, and merchant ID.

The service manager 105 allows the user to configure the initial prompt for payment type or card swipe. When it is set for payment type, the cashier or customer needs to select a payment method before a card is swiped. If the system is set for card swipe, the customer is asked to swipe the card before a payment method is selected. By configuring the service manager 105, the user may select prompting by a POS device or prompting by the payment window of the service manager 105. If the service manager 105 is configured to prompt for amount of payment by the POS device, the prompt signal will appear on the screen of the POS device (e.g., a card reader). The POS device 125 then reads amount of payment entered from its key pad. If the service manager 105 is configured to prompt for amount of payment on the payment window of the service manager 105, the service manager 105 prompts for and reads amount of payment entered from the keyboard of the computer of the payment system 100.

Under the Hardware setup menu are Receipt Printer, Card Reader, and Pin Pads. Receipt Printer allows the user to change the margin of receipts and the print device; Under the Card Reader menu, the user may select card reader type and communication port; and the Pin Pads menu allows the user to select pin pads type, communication port, and key management. The Advance menu under Pin Pals further allows the user to change baud rate, communication port, and time out.

The Payments menu consists of Interface (FIG. 2), which allows the user to set up input file and output file formats and the directory where the service manager 105 reads and writes file. The File menu (not shown in FIGS) contains End, which allows the user to end all windows so that the program runs in the background. The Transaction menu contains submenus: Credit, Debit, EBT, and optionally Check. By clicking on those menus, the user launches payment windows, respectively for credit card, debit/ATM card, EBT, and check payment windows.

After an initial setup is complete, the user can write selected values to a configuration file in the form of key-value pair. The information is saved in the configuration file upon exit. When the program is launched next time, the service manager 105 reads the configuration file and assigns the values to corresponding controlling variables. When the service manager 105 is set up for a non-integrated payment system, the value of the control variable causes the service manager 105 to execute only the portion of code controlling functions of non-integrated system. When it is set up as an integrated system, the value of this controlling variable causes the service manager 105 to execute only the code controlling the functions of the integrated payment system. Because all of those global variables are assigned with proper values, the service manager 105 acts in an anticipated way as more fully discussed in the flowcharts for each payment method.

After an initial set up is completed, it needs to be turned on under the Control Panel under the Tool menu. After the start button is pressed once, the service manager 105 automatically begin to operate in the background of the computer 110 as a window service. To disable to the service manager 105 without uninstalling it, the user can press the stop button under the Control Panel under the Tools menu.

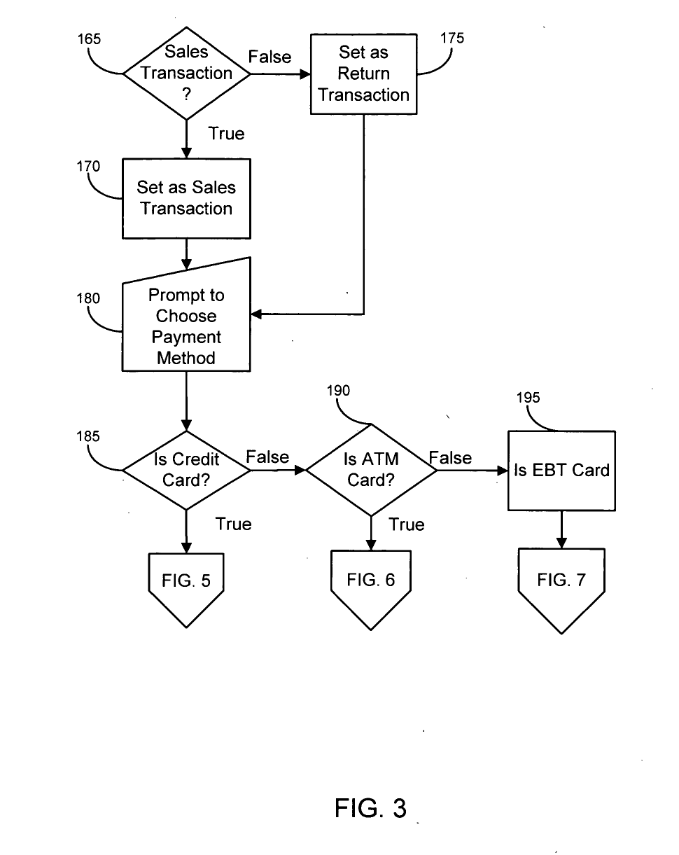

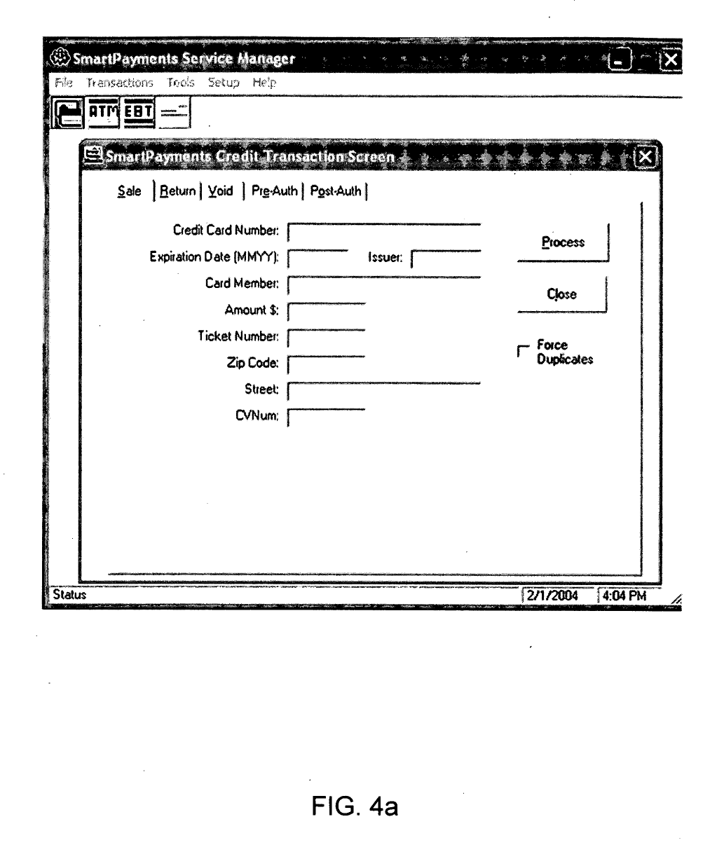

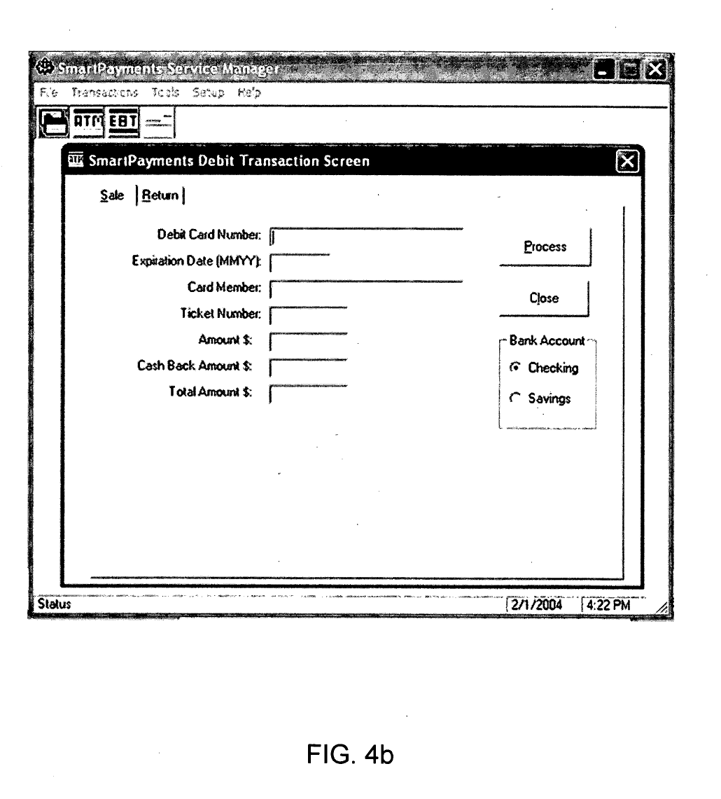

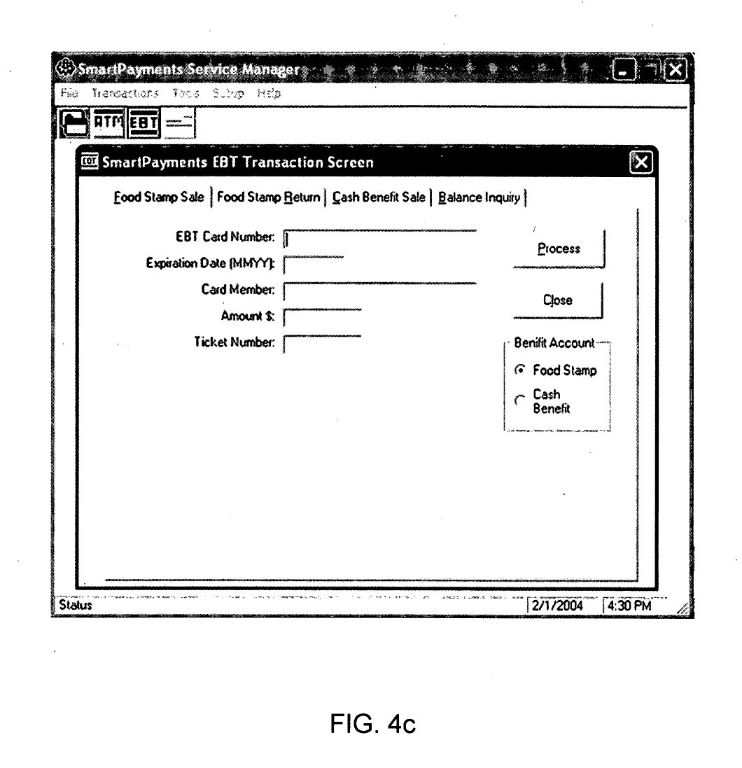

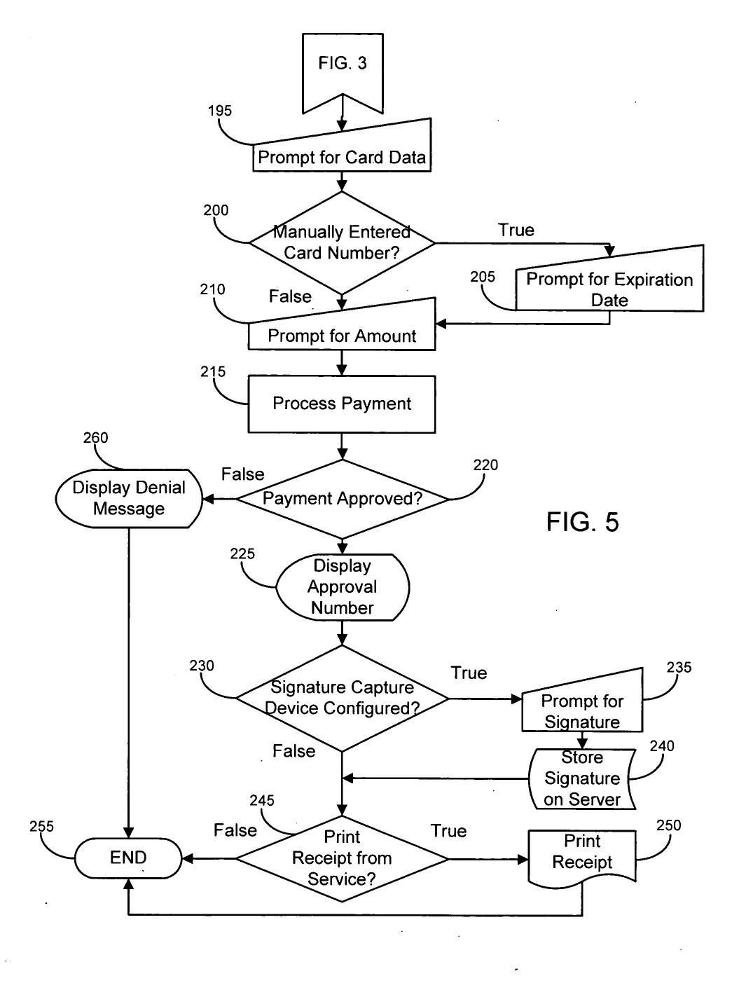

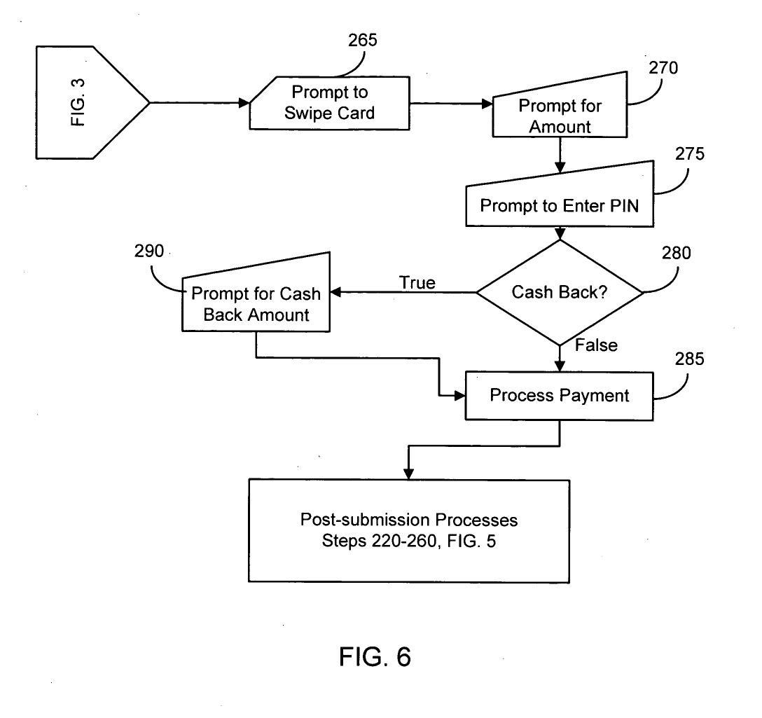

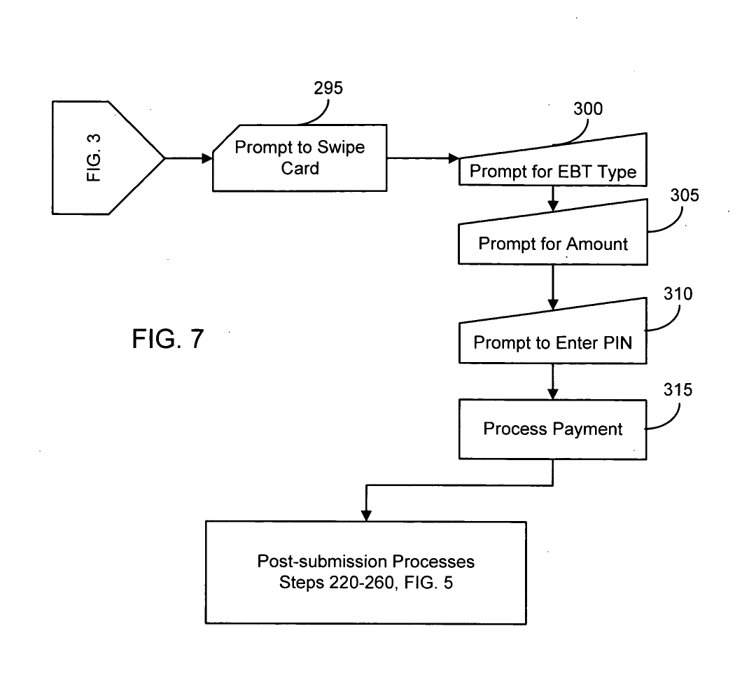

If the user sets up the service manager 105 to run the payment system 100 as a non-integrated payment system, the detailed steps are shown in FIG. 3. In this case, the system prompts the user to select a transaction type between a sale transaction and a return transaction (block 165). If the user chooses a sale transaction, the service manager 105 sets the transaction as sale transaction (block 170). If the user chooses a return transaction (block 165, the system sets the transaction as a return transaction (block 175). Optionally, the user may choose from void payment, pre-authorization and post-authorization (not shown). Then, the service manager 105 prompts for payment method among credit card, debit or ATM card, and EBT card (block 180). When the user selects a payment method, the service manager 105 determines if credit card is selected as a payment method (block 185). If it is true, it proceeds with the steps shown in FIG. 5. If credit card is not a selected method, the service manager 105 then determines if debit or ATM card is selected (block 190). If debit or ATM card is the selected method, the service manager 105 proceeds with the steps shown in FIG. 6. Otherwise, the service manager 105 determines if EBT card is selected (block 195). If it is EBT card, the service manager 105 then proceeds with the steps in FIG. 7. The payment system 100 displays a corresponding payment window (FIG. 4a-4c), which allows the user to enter card information and amount of payment, respectively for the selected payment methods: credit card, debit or ATM card, and EBT card.

When the payment method is a credit card, the service manager 105 prompts for credit card data (FIG. 4a). The subsequent steps are shown in FIG. 5. The service manager 105 prompts for card data (block 185). It asks if card data is inputted manually through the payment window (block 200). If the user selects manual input, the service manager 105 then prompts for an expiration date (block 205). After the user enters the expiration date into the payment window, the service manager 105 then prompts for amount of payment (block 210). If the user does not select manually entered card number, it then proceeds with the step of prompting for amount (block 210). The user enters the amount by computer keyboard into the payment window (shown in FIG. 4a), or by the key (there are limited number of key) in the card reader if the card reader is set up to prompt for amount of payment. After all data is properly entered, the user then clicks the process button (e.g., the OK button) to allow the payment system 100 to start processing the payment transaction (block 215).

Upon submission, the payment data is sent to the payment-processing server 130, which then verifies the validity of the customer account and credit line (block 220). If the payment is approved, it returns an authorization code to the service manager 105, which displays the code (block 225). Then, the service manager 105 determine if a signature-capturing device is present and properly configured (block 230). If the device is properly configured, the service manager 105 prompts the customer to sign on the device (block 235). It then acquires the signature in a suitable file format and sends it to the payment-processing server 130 for record (block 240 and then proceeds with the step in block 245. If no functioning signature-capturing device is found in block 230, the service manager 105 checks if a printer is connected and properly configured (block 245) for printing receipts. If a proper printer is found, it prints a signature slip for the customer to sign (block 250). The payment system 100 ends (block 255) and is ready for next operation. If payment was not approved in block 260, the payment system 100 terminates and displays a denial message.

If debit card is chosen as the payment method, the process steps executed by the service manager 105 are similar to those for credit card except that it sequentially prompt for swiping the card, amount of payment, and a PIN number (PIN number can only be entered by the card device), as shown in FIG. 6. The difference can be seen by comparing the process steps shown in FIGS. 5 and 6. It prompts to swipe card in block 265, then prompts for amount (block 270) and prompt for PIN number (block 275). Those three steps are necessary and cannot be by-passed. In addition, it also optionally prompts for cash back (block 280). If the customer enters No, the service manager 105 proceeds with payment process in block 285. If the customer enters Yes for cash back, the service manager 105 then prompts for the amount of cash back (block 290). After all required data is properly entered, the user can start the service manager 105 to process the payment transaction (block 285). The steps of all post-submission processes are substantially the same as those described for the credit card payment transaction in FIG. 5.

If an EBT card is selected as payment method, the service manager 105 proceeds with the steps shown in FIG. 7. The service manager 105 prompts sequentially for swiping the card (block 295), EBT type (block 300), amount of payment (block 305), and a PIN number (block 310). The required payment data is substantially the same as those shown in FIG. 4c. When all required data is entered, the payment data is submitted for processing (block 315). The steps for all post-submission processes are substantially the same as those for the credit card payment transaction shown in FIG. 5.

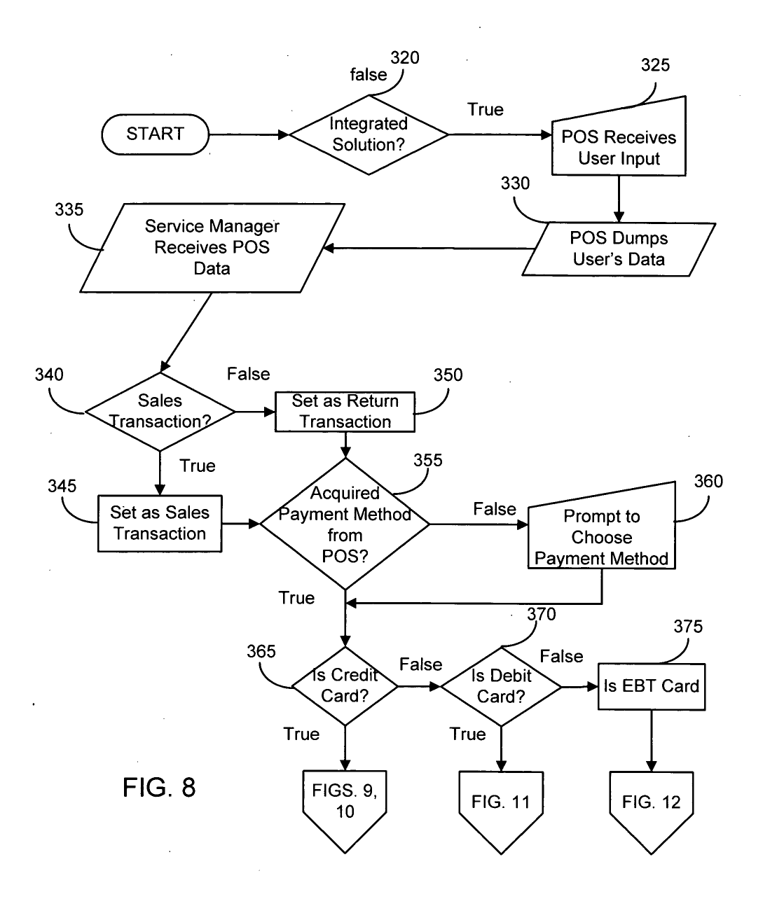

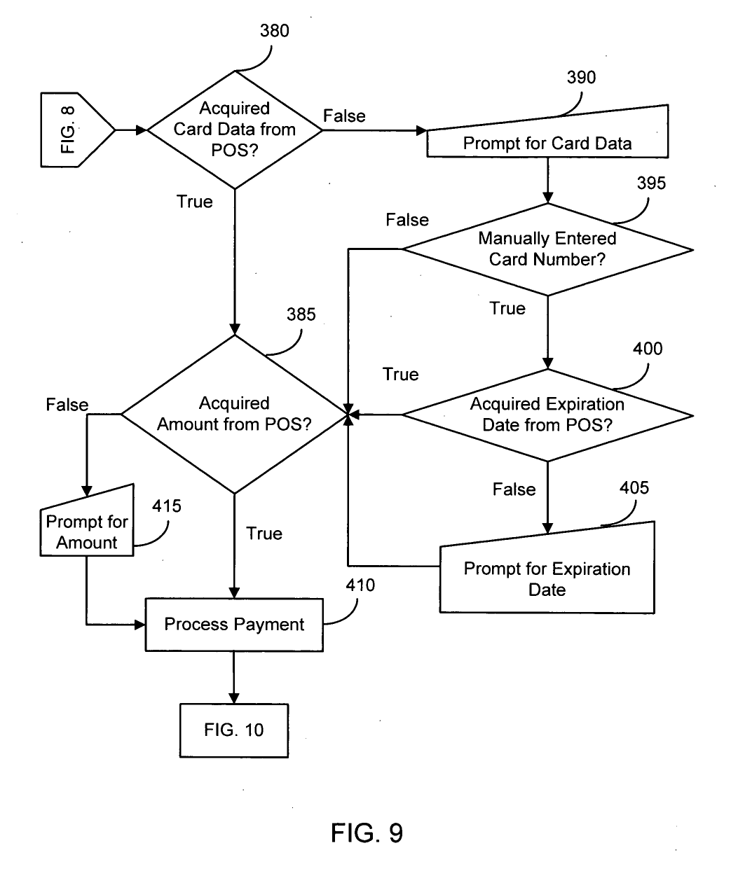

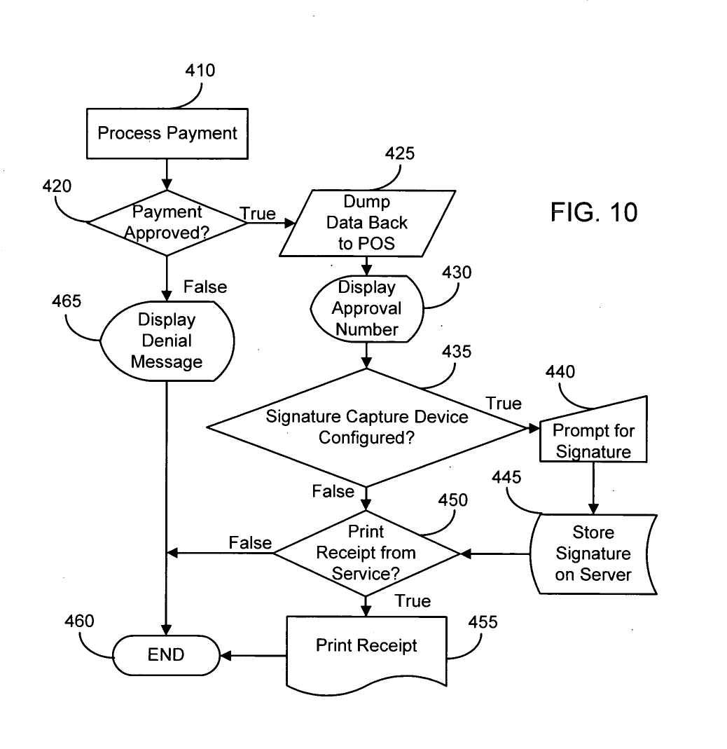

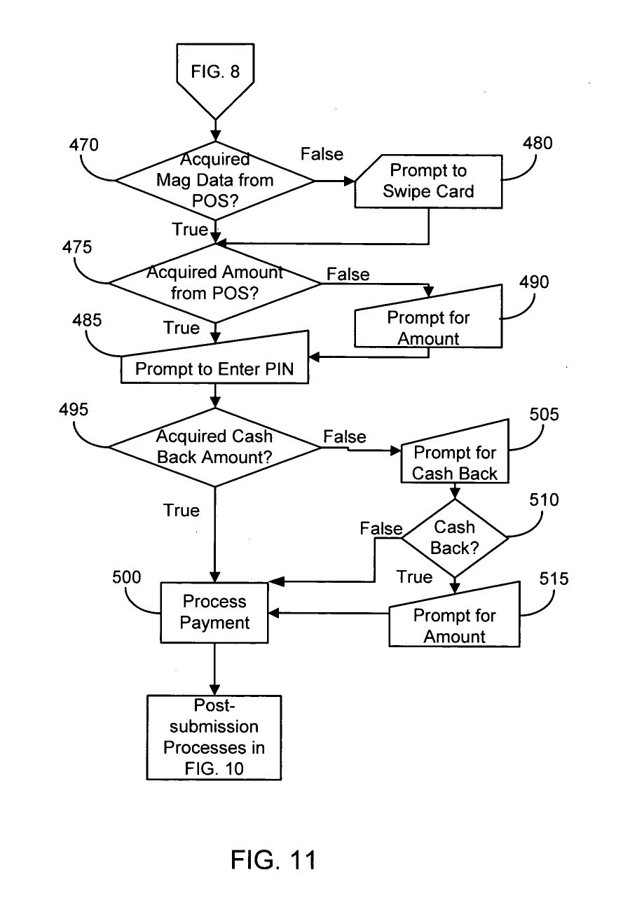

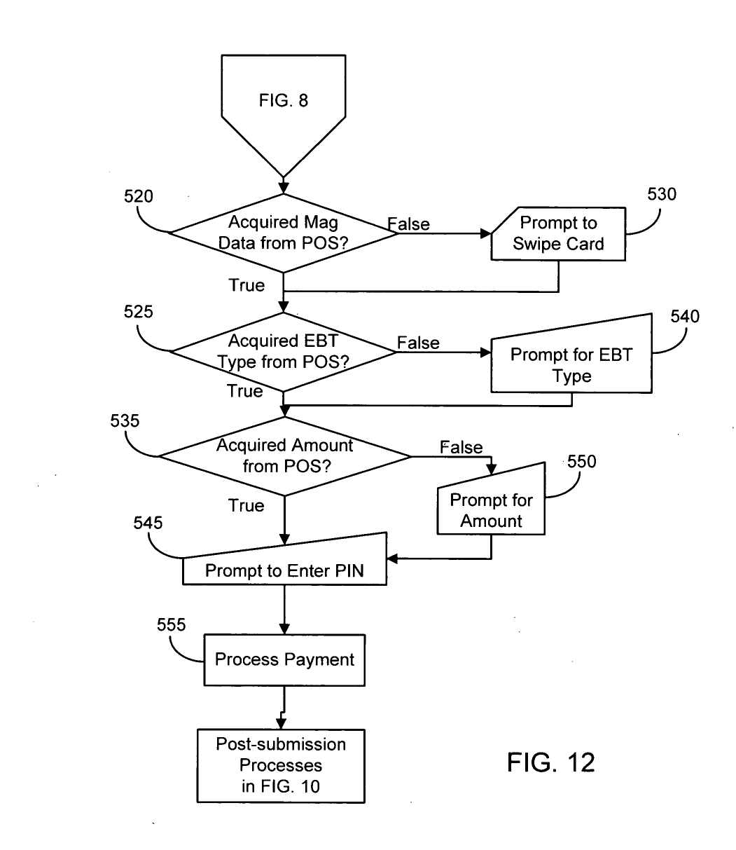

When the system is configured as an integrated payment-POS inventory system (block 320), the steps of processes from start to the selecting a payment method is shown in FIG. 8. First, the POS system 145 receives user input to create sale transaction form such as billing statement or a sale receipt (block 325). The POS system 145 then writes the data for the transaction, to the directory (which is the input directory of the service manager 105 (block 330). Upon the writing of the data, the user then moves the service manager 105 from the background to the foreground, and picks up the transaction data (block 335). The service manager 105 then decides whether the transaction to be processed is a sale transaction (block 340). If it has been set as a sale transaction in block 340, the service manager 105 then sets it as such (block 345) and proceeds. If it determines that it is not a sales transaction (block 340), it sets it as return transaction (block 350) and proceeds. Then, the service manager 105 tries to acquire payment type from the data acquired from the POS system 145 (block 355). If it is unable to acquire a payment type in block 355, it prompts the user to choose payment type (block 360) and proceeds with the step in block 365. Thereafter, it sequentially determines if it is one of the payment methods. First, it determines if it is credit card (block 365). If it is true, it proceeds with the steps for credit payment in FIGS. 9 and 10. If it is not a credit card, the service manager 105 then determines if the payment method is a debit or ATM card (block 370). If it is true, the service manager 105 then proceeds with the steps in FIG. 11. If it is not a debit or ATM card, it then determines if the payment method is an EBT card (block 375). If it is true, the service manager 105 proceeds with the steps in FIG. 12.

If the payment method is credit card, the service manager 105 follows the steps shown in FIG. 9. The service manager 105 first acquires card data from the POS system 145 (block 380). If it succeeds, it acquires amount of payment from the POS system 145 (block 385). If it is unable to acquire the card data in block 380, it prompts for credit card number (block 390). If no card number is manually entered in block 395, it proceeds with the step in (block 385). If the service manager 105 gets a manually entered card number in block 395, it then tries to acquire an expiration date from the POS system 145 (block 400). If it succeeds in acquiring an expiration date, it goes to block 385. If it fails to acquire the expiration date, it prompts for and reads the expiration date from the payment window (block 405). The service manager 105 tries to acquire amount of payment from the file of the POS system 145 in the step of block 385. If it succeeds, it is then ready for processing payment in block 410. If it is unable to acquire amount of payment in block 385, it prompts the user to input amount of payment through the payment window (same as the one shown in FIG. 4a) (block 415). Upon receiving amount of payment, the service manager 105 is ready for processing payment in block 410. The steps of post-submission processes are shown in FIG. 10.

When all data are properly entered in all fields, the user then submits the payment transaction for processing in the last step in FIG. 9 (block 410 in FIG. 10). All post submission processes are shown in FIG. 10. The payment-processing server 130 responds with an authorization code if the payment is approved (block 420). If the service manager 105 receives an authorization code, it writes data to the directory for the POS system 145 (block 425). The service manager 105 then displays approval number (block 430). The service manager 105 then checks to determine if a signature-capturing device is connected and properly configured (block 435). If it does, it prompts the customer to sign a signature on the signature pad of the device (block 440), and then captures and sends a copy of the signature in a suitable format to the payment-processing server 130 for record (block 445) and proceeds with the step in block 410. Optionally, it may save a copy in the computer 110. If the service manager 105 detects no functional signature-capturing device in block 435, it then determines whether a receipt is printed (block 450). If it is true, the service manager 105 prints a receipt (block 455) and ends at block 460. If the payment-processing server 130 denies the payment in block 420, the service manager 105 displays a message of denial in block 465 and terminates the payment process in block 460.

Referring back to FIG. 8, if the payment method is an ATM or a debit card, it runs subsequent steps in according to the flowchart shown in FIG. 11. If the service manager 105 successfully acquires the card data from the POS system 145 (block 470), it then proceeds with acquiring amount of payment in block 475. If it is unable to acquire the card data from the POS system 145 in block 470, the service manager 105 prompts the customer to swipe the card to read card number and expiration date (block 480). After the service manager 105 successfully gets the card data manually or by acquisition, it then tries to acquire amount of payment from the POS system 145 (block 475). If it successfully acquires amount of payment, it then proceeds with prompting for PIN number (block 485). If it fails to acquire amount of payment, the service manager 105 then prompts the user to enter the amount (block 490). After the service manager 105 successfully gets amount of payment manually or by acquisition, it prompts and reads the PIN number (block 485). This step cannot be bypassed. Optionally, the service manager 105 checks if the customer wants to have cash back (block 495). If it is positive, the service manager 105 goes ahead to process the payment (block 500). If the service manager 105 get no cash back amount form the POS system 145, it then prompts the customer to choose whether the customer wants to get cash back (block 505). If the customer chooses No in block 510, the service manager 105 proceeds with (block 500), or else, it prompts the customer to enter the amount of cash back (block 515). The service manager 105 then is submitted in block 500.

The payment transaction is sent to the payment-processing server 130 for processing. The payment-processing server 130 then verifies the validity of the customer account and credit line, to determine whether or not the payment is approved. The service manager 105 writes data to the export directory. The service manager 105 then displays the authorization code. Post submission steps are substantially same as those described in FIG. 10.

Referring back to FIG. 8, if the payment method is an EBT card, it runs subsequent steps according to the flowchart shown in FIG. 12. If the service manager 105 acquires card data from the POS system 145 (block 520), it then proceeds with acquiring EBT type from the POS system 145 (block 525). If the service manager 105 is unable to acquire card data, it then prompts the customer to swipe the card, and reads the card data from the card device (block 530). After it gets the card data manually or by acquisition, it then proceeds with acquiring EBT type from the POS system 145 (block 525). If it is able to acquire the EBT type in block 525, it proceeds with acquiring amount of payment (block 535). If the service manager 105 is unable to acquire the EBT type in block 525, it prompts the customer to enter EBT type in block 540 and proceeds with the step of block 535 for acquiring amount of payment. If the service manager 105 successfully acquires amount of payment in block 535, it proceeds with prompting for PIN (block 545). It if is unable to acquire amount of payment from the POS system 145 in block 535, it prompts for amount of payment and reads inputted amount of payment in block 550 and proceeds with the step of block 545. At block 545, the service manager 105 prompts for a PIN number and reads it. The data collected by the service manager includes the data for all data fields in the payment window in FIG. 4c. The user then submits the payment to the payment-processing server 130 for processing in block 555.

If the request of payment is approved, the service manager 105 sends authorization code and other information back to the POS system 145. The service manager 105 then displays the authorization code and proceeds with post-submission processes which are substantially the same as those shown in FIG. 10. When selected payment method and scanned data from the POS system 145 is inconsistent, the service manager 105 determines from the information scanned from card reader whether it overrides the payment type acquired from the POS system 145.

As in any software application, flowcharts show the logic step. In most of the time, when a step cannot be performed, the service manager does not continue to perform the step until a proper value is entered for that prompt. If the user attempts to submit a payment-processing request to the payment-processing server 130 and does not contain all required information, the service manager 105 returns an error message. By way of example, if the user submits a payment request while no expiration date is specified, the service manager 105 returns an error message.

There are additional flexibilities achievable by using the Setup menu. For example, the prompts for card swiping, payment method and payment amount may be prompted on the payment information window (FIGS. 4a-4c) or on the small display window of the card reader or other equivalent device attached to the computer 110.

While preferred embodiment is developed using the Visual Basic 6.0 for Microsoft Windows 95, 98, ME, 2000 and XP, it can be easily modified and be compiled for the computers of different architecture and operating systems. While graphic user interface is preferred, it is not essential, either. Text user interface may be used to achieve essentially the same purposes. For example, the interaction between the service manager 105 and customer or cashier may be done by text dialogs, which allows the user to select a number. The values of the variables can be set, for example, by a case statement or other read statement in virtually any of the well-known programming languages such as C++, C, Fortran, and PASCAL. If the program is run in a text mode, menu is displayed as a line of text with a number. The user may enter a corresponding number to select a particular part of code.

In those exemplary embodiments of the present invention, specific components, hardware parts, arrangements, and processes are used to describe the invention. Obvious changes, modifications, and substitutions may be made by those skilled in the art to achieve the same purpose of the invention. The exemplary embodiments are, of course, merely examples and are not intended to limit the scope of the invention. It is intended that the present invention include all other embodiments that are within the scope of the claims and their equivalents.

1. A payment system of using cards to process payments using a payment-processing server in the payment network, the payment system being able to integrate with a POS system connected to the payment system, the POS system running a POS application, the payment system comprising:
(1) a computer running a suitable operating system;
(2) at least one payment device selected from the group comprising a card reader, wedge card reader, signature capture device, and check image capture device, the payment device being connected to the computer;
(3) a network interface connected to the computer;
(4) a network connection connecting the interface of the computer to the payment-processing server in the network; and
(5) a service manager running in the computer wherein the service manager has (1) configuring means for assigning values to a set of controlling variables whereby the payment system may be configured as a stand-alone payment system or integrated payment system, (2) switching means for activating the process of the service manager, and (3) data-exchanging means for exchanging data between the payment system and the POS system, wherein the service manager and the POS application reside on the same computer, wherein in response to the service manager configuring means being configured as a stand-alone payment system the payment system acts separately from the POS system, and wherein in response to the system being configured as an integrated system the payment system interacts with the POS system.

2. The payment system of claim 1, wherein the configuring means is a setup menu in graphic use interface, wherein the data-exchanging means is a file directory which can be accessed by both the payment system and the POS system, and wherein the switching means is a button on the setup page for activating the process of the service manager, the payment system further comprising a printer being connected to the computer and configured for printing sale receipts.

3-10. (canceled)

11. A method of using a card to process a payment using a payment system connected to a payment-processing server in the payment network, the payment system consisting of a computer, at least one payment device connected to the computer, and a service manager installed in the computer controlling the payment system, the payment system being able to integrate with a POS system connected to the payment system, the POS system running a POS application residing on the same computer as the service manager, the method comprising the steps of:
(1) installing the service manager in the computer of the payment system, the service manager having (a) configuring means for assigning values to a set of controlling variables in a setup menu, (b) switching means for activating the process of the service manager, and (c) data-exchanging means for exchanging data between the payment system and the POS system wherein in response to the service manager configuring means being configured as a stand-alone payment system the payment system acts separately from the POS system, and wherein in response to the system being configured as an integrated system the payment system interacts with the POS system;
(2) configuring the setup menu of the service manager so that the payment system works as a non-integrated payment system;
(3) launching the process of the service manager;
(4) prompting for the swiping of the card;
(5) reading card information from the card;
(6) prompting for amount of payment in the display screen of the payment device or the payment window of the service manager;
(7) reading amount of payment;
(8) submitting a payment request to the payment-processing server in the payment network for processing;
(9) accepting a response and authorization code from the payment processing server;
(10) displaying an approval message on the window of the service manager;
(11) prompting for and acquiring a signature of the customer of the card;
(12) storing the signature on the payment-processing server; and
(13) printing a receipt through the printer.

12. The method of claim 11, wherein the card the service manager reads is a credit card.

13. The method of claim 11, wherein the card the service manager reads is a debit card, the method further comprising the steps of prompting for a PIN number and reading the PIN number entered by the customer.

14. The method of claim 11, wherein the card the service manager reads is an EBT card, the method further comprising the steps of prompting for EBT card type and a PIN number and reading the information on the EBT card type and the PIN number.

15. A method of using a card to process a payment using an integrated payment system connected to a payment-processing server in the payment network, the payment system consisting of a computer, at least one payment device connected to the computer, and a service manager installed in the computer controlling the payment system, the payment system being able to integrate with a POS system connected to the payment system, the POS system running a POS application residing on the same computer as the service manager, the method comprising the steps of:
(1) installing the service manager in the computer of the payment system, the service manager having (a) configuring means for assigning values to a set of controlling variables in a setup menu, (b) switching means for activating the process of the service manager, and (c) data-exchanging means for exchanging data between the payment system and the POS system, wherein in response to the service manager configuring means being configured as a stand-alone payment system the payment system acts separately from the POS system, and wherein in response to the system being configured as an integrated system the payment system interacts with the POS system;
(2) configuring the setup menu of the service manager so that the payment system works as a payment system integrated with the POS system whereby the payment system and the POS system are able to exchange data using the data exchanging means;
(3) launching the service manager;
(4) acquiring the card information from the payment device;
(5) acquiring amount of payment from the POS application using the data exchange means;
(6) submitting a request of the payment to the payment-processing server in the payment network for processing;
(7) accepting the response and authorization code from the payment processing server;
(8) sending the authorization code to the POS application by using the data exchange means;
(9) displaying a message of approval and the authorization code;
(10) prompting for and acquiring a signature of the customer of the card;
(11) storing the signature on the payment-processing server; and
(12) printing a receipt through the printer.

16. The method of claim 15, wherein the card the service manager reads is a credit card.

17. The method of claim 16, further comprising prompting for the swiping of the card and reading the card if it is unable to read card data from the POS system.

18. The method of claim 15, wherein the card the service manager reads is an EBT card, the method further comprising the steps of prompting for EBT card type and a PIN number and reading the information on the EBT card type and the PIN number.

19. The method of claim 18, further comprising prompting for the swiping of the card and reading the card if it is unable to read card data from the POS system.

20. The method of claim 15, further comprising prompting for the swiping of the card and reading the card if it is unable to read card data from the POS system.

21. A computer program product for use by a payment system to process payments using a payment-processing server in the payment network, the computer program product comprising a non-transitory computer usable medium having computer readable code embodied on the medium, the computer program code further comprising:
(1) computer program code for assigning values to a set of controlling variables in a setup menu so that the payment system can be configured as a stand-alone payment system or a payment system integrated with a POS system running a POS application, wherein the computer program code and the POS application reside on the same computer, wherein in response to the service manager configuring means being configured as a stand-alone payment system the payment system acts separately from the POS system, and wherein in response to the system being configured as an integrated system the payment system interacts with the POS system.;
(2) computer program code for starting the payment system; and
(3) computer program code for exchanging data between the payment system and the POS system.

22. The computer program product of claim 21, further comprising the computer program code for installing the computer readable code in a computer running a proper operating system.
